(19) United States
(12) Patent Application Publication
(10) Pub. No.: US 2021/0368797 A1
(43) Pub. Date: Dec. 2, 2021

(54) COMPOSITIONS COMPRISING HALAUXIFEN AND OTHER HERBICIDES AND METHODS THEREOF

(71) Applicant: DOW AGROSCIENCES LLC, Indianapolis, IN (US)

(72) Inventors: Christopher John Voglewede, Pittsboro, IN (US); Richard Kevin Mann, Franklin, IN (US); Luiz Henrique Zobiole, Toledo (BR); Augusto Kalsing, Sao Paulo (BR); Gizelly G. Santos, Campo Grande (BR)

(73) Assignee: DOW AGROSCIENCES LLC, Indianapolis, IN (US)

(21) Appl. No.: 17/290,233

(22) PCT Filed: Oct. 31, 2019
(86) PCT No.: PCT/US19/59010

§ 371 Date: Apr. 29, 2021

Related U.S. Application Data
(60) Provisional application No. 62/755,083, filed on Nov. 2, 2018.

(51) Int. Cl. A01N 57/20; A01N 43/40; A01N 37/40

(52) U.S. Cl. CPC A01N 57/20; A01N 37/40; A01N 43/40

(57) ABSTRACT

A herbicidal composition containing (a) a compound of formula (I):

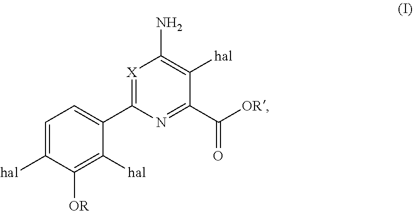

wherein X represents CH or N, hal represents F, Cl or Br, R is methyl or ethyl, and R′ is H, methyl or ethyl, or an agriculturally acceptable salt or ester thereof, (b) a second herbicide comprising at least one phenoxy herbicide, or an agriculturally acceptable salts, esters, and amides thereof; and/or (c) a third herbicide comprising at least one organophosphorus herbicide, or an agriculturally acceptable salts, esters, and amides thereof, provides control of undesirable vegetation e.g., in direct-seeded rice, water-seeded rice, transplanted rice, cereals, wheat, barley, oats, rye, sorghum, corn or maize, sugarcane, sunflower, oilseed rape, canola, sugar beet, soybean, cotton, pineapple, vegetables, pastures, grasslands, rangelands, fallowland, turf, tree and vine orchards, aquatics, plantation crops, vegetables, industrial vegetation management (IVM) and rights of way (ROW).

### CROSS-REFERENCE TO RELATED APPLICATIONS

This application is an International Application, which claims priority to U.S. Provisional Application No. 62/755,083, filed Nov. 2, 2018, titled COMPOSITIONS COMPRISING HALAUXIFEN AND OTHER HERBICIDES AND METHODS THEREOF, the entire contents of which are incorporated herein by reference.

### FIELD

Provided herein includes herbicidal compositions comprising at least one herbicidal pyridine or pyrimidine carboxylic acid, a second herbicide, and a third herbicide, or agriculturally acceptable salts, esters and amides thereof. Provided herein are also methods of controlling undesirable vegetation comprising applying the compositions disclosed herein.

### BACKGROUND

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. However, there remains a need for compositions and methods that are effective in controlling undesirable vegetation.

### SUMMARY

A first embodiment provided herein includes herbicidal compositions comprising an herbicidally effective amount of (a) a compound of the Formula (I):

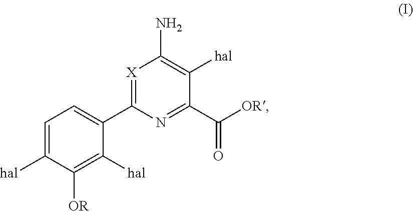

wherein X represents CH or N, hal represents F, Cl or Br, R represents methyl or ethyl, and R′ represents H, methyl or ethyl, or an agriculturally acceptable salts, esters, and amides thereof; (b) a second herbicide comprising at least one phenoxy herbicide, or an agriculturally acceptable salts, esters, and amides thereof; and/or (c) a third herbicide, or an agriculturally acceptable salts, esters, and amides thereof.

A second embodiment includes the composition according to the first embodiment, wherein Formula (I) is present in at least one of the following forms: a carboxylic acid, a carboxylate salt, an aralkyl, an alkyl ester, an unsubstituted benzyl, a substituted benzyl, a C1-4 alkyl, and/or an n-butyl ester.

A third embodiment includes the composition according to the first or the second embodiments, wherein the second herbicide (b) comprises at least one phenoxy herbicide, or an agriculturally acceptable salts, esters, and amides thereof.

A fourth embodiment includes the composition according to any one of the first to the third embodiments, wherein the second herbicide (b) comprises at least one compound selected from the group consisting of: 2,4-D, 2,4-D EHE, 2,4-D DMA, 2,4-D choline, and/or 2,4-DB.

A fifth embodiment includes the composition according to any one of the first to the fourth embodiments, wherein the third herbicide (c) comprises at least one organophosphorus herbicide, or an agriculturally acceptable salts, esters, and amides thereof.

A sixth embodiment includes the composition according to any one of the first to the fifth embodiments, wherein the third herbicide (c) comprises at least one compound selected form the group consisting of: glufosinate, amiprofos-methyl, anilofos, bensulide, bilanafos, butamifos, fosamine, and piperophos, or an agriculturally acceptable salts, esters, and amides thereof.

A seventh embodiment includes the composition according to any one of the first to the sixth embodiments, wherein the second herbicide in the composition is at least one compound selected from the group consisting of: 2,4-D, 2,4-D EHE, 2,4-D DMA, 2,4-D choline, and/or 2,4-DB, wherein the weight ratio of the compound of Formula (I) to the at least one compound selected from the group consisting of: 2,4-D, 2,4-D EHE, 2,4-D DMA, 2,4-D choline, and/or 2,4-DB given in units of gai/ha to gai/ha (grams active ingredient per hectare) or gae/ha to gae/ha (grams acid equivalent per hectare) comprises from about from about 1:1000 to about 1:1, from about 1:500 to about 1:1, from about 1:400 to about 1:1, from about 1:300 to about 1:1, from about 1:200 to about 1:1, from about 1:190 to about 1:1, from about 1:180 to about 1:1, from about 1:170 to about 1:1, from about 1:160 to about 1:1, from about 1:150 to about 1:1, from about 1:140 to about 1:1, from about 1:130 to about 1:1, from about 1:120 to about 1:1, from about 1:110 to about 1:1, from about 1:100 to about 1:1, from about 1:90 to about 1:1, from about 1:80 to about 1:1, from about 1:70 to about 1:1, from about 1:60 to about 1:1, from about 1:50 to about 1:1, from about 1:40 to about 1:1, from about 1:30 to about 1:1, from about 1:25 to about 1:1, from about 1:20 to about 1:1, from about 1:13 to about 1:1, from about 1:12.5 to about 1:1, from about 1:10 to about 1:1, from about 1:9 to about 1:1, from about 1:8 to about 1:1, from about 1:7 to about 1:1, from about 1:6 to about 1:1, from about 1:5 to about 1:1, from about 1:4 to about 1:1, from about 1:3 to about 1:1, from about 1:2 to about 1:1, from about 1:1 to about 1:1, about 1:1, about 1:2, about 1:4, about 1:5, about 1:10, about 1:12.5, about 1:25, about 1:50, about 1:100, about 1:120, about 1:130, about 1:131, about 1:132, about 1:133, about 1:134, about 1:135, about 1:136, about 1:137, about 1:138, about 1:139, about 1:140, about 1:150, about 1:200, about 1:250, about 1:300, about 1:350, about 1:400, about 1:450, about 1:500, or any combination thereof.

An eighth embodiment includes the composition according to any one of the first to the seventh embodiments, wherein the third herbicide in the composition is glufosinate or an agriculturally acceptable salts, esters, and amides thereof, wherein the weight ratio of the compound of Formula (I) to glufosinate or an agriculturally acceptable salts, esters, and amides thereof given in units of gai/ha to gai/ha or gae/ha to gae/ha comprises from about 1:1000 to about 1:1, from about 1:500 to about 1:1, from about 1:400 to about 1:1, from about 1:300 to about 1:1, from about 1:200 to about 1:1, from about 1:100 to about 1:1, from about 1:90 to about 1:1, from about 1:80 to about 1:1, from about 1:79 to about 1:1, from about 1:78 to about 1:1, from about 1:77 to about 1:1, from about 1:76 to about 1:1, from about 1:75 to about 1:1, from about 1:74 to about 1:1, from about 1:73 to about 1:1, from about 1:72 to about 1:1, from about 1:71 to about 1:1, from about 1:70 to about 1:1, from about 1:60 to about 1:1, from about 1:50 to about 1:1, from about 1:40 to DAS-78324-US-PCT about 1:1, from about 1:30 to about 1:1, from about 1:25 to about 1:1, from about 1:20 to about 1:1, from about 1:13 to about 1:1, from about 1:12.5 to about 1:1, from about 1:10 to about 1:1, from about 1:9 to about 1:1, from about 1:8 to about 1:1, from about 1:7 to about 1:1, from about 1:6 to about 1:1, from about 1:5 to about 1:1, from about 1:4 to about 1:1, from about 1:3 to about 1:1, from about 1:2 to about 1:1, from about 1:1 to about 1:1, about 1:1, about 1:2, about 1:4, about 1:5, about 1:10, about 1:12.5, about 1:25, about 1:50, about 1:60, about 1:70, about 1:71, about 1:72, about 1:73, about 1:74, about 1:75, about 1:76, about 1:77, about 1:78, about 1:79, about 1:80, about 1:90, about 1:100, about 1:150, about 1:200, about 1:250, about 1:300, about 1:350, about 1:360, about 1:365, about 1:370, about 1:380, about 1:390, about 1:400, about 1:450, about 1:500, or any combination thereof.

A ninth embodiment includes the composition according to any one of the first to the eighth embodiments, wherein the composition comprises the compound of Formula (I), the second herbicide, and the third herbicide.

A tenth embodiment includes the composition according to any one of the first to the ninth embodiments, wherein the second herbicide in the composition is at least one compound selected from the group consisting of: 2,4-D, 2,4-D EHE, 2,4-D DMA, 2,4-D choline, and 2,4-DB, and the third herbicide is glufosinate or an agriculturally acceptable salts, esters, and amides thereof, wherein the weight ratio of the compound of formula (I) or an agriculturally acceptable salts, esters, and amides thereof to at least one compound selected from the group consisting of: 2,4-D, 2,4-D EHE, 2,4-D DMA, 2,4-D choline, and 2,4-DB to glufosinate or an agriculturally acceptable salts, esters, and amides thereof given in units of gai/ha to gai/ha or gae/ha to gae/ha comprises from about 1:1000:500 to about 1:1:1, from about 1:500:500 to about 1:1:1, from about 1:400:400 to about 1:1:1, from about 1:1000:500 to about 1:130:70, from about 1:500:500 to about 1:130:70, from about 1:400:400 to about 1:130:70, from about 1:400:400 to about 1:12:1, from about 1:400:400 to about 1:12.5:1.8, from about 1:400:70 to about 1:25:2, from about 1:400:300 to about 1:50:4, from about 1:300:300 to about 1:1:1, from about 1:200:200 to about 1:1:1, from about 1:100:100 to about 1:1:1, from about 1:90:70 to about 1:1:1, from about 1:80:70 to about 1:1:1, from about 1:70:70 to about 1:1:1, from about 1:60:60 to about 1:1:1, from about 1:50:50 to about 1:1:1, from about 1:40:40 to about 1:1:1, from about 1:30:30 to about 1:1:1, from about 1:25:25 to about 1:1:1, from about 1:20:20 to about 1:1:1, from about 1:13:13 to about 1:1:1, from about 1:12.5:12.5 to about 1:1:1, from about 1:10:10 to about 1:1:1, from about 1:9:9 to about 1:1:1, from about 1:8:8 to about 1:1:1, from about 1:7:7 to about 1:1:1, from about 1:6:6 to about 1:1:1, from about 1:5:5 to about 1:1:1, from about 1:2:2 to about 1:1:1, from about 1:1:1 to about 1:1:1, about 1:1:1, about 1:2:2, about 1:4:4, about 1:5:5, about 1:10:10, about 1:12.5:12.5, about 1:25:25, about 1:50:50, about 1:100:100, about 1:150:150 about 1:200:200, about 1:250:250, about 1:300:300, about 1:350:350, about 1:400:400, about 1:450:450, about 1:500:500, about 1:50:70, about 1:100:70, about 1:130:70, about 1:131:70, about 1:132:70, about 1:133:70, about 1:134:70, about 1:135:70, about 1:136:70, about 1:137:70, about 1:138:70, about 1:139:70, about 1:140:70, about 1:150:70, about 1:200:70, about 1:250:70, about 1:300:70, about 1:350:70, about 1:400:70, about 1:450:70, about 1:500:70, about 1:50:75, about 1:100:75, about 1:130:75, about 1:131:75, about 1:132:75, about 1:133:75, about 1:134:75, about 1:135:75, about 1:136:75, about 1:137:75, about 1:138:75, about 1:139:75, about 1:140:75, about 1:150:75, about 1:200:75, about 1:250:75, about 1:300:75, about 1:350:75, about 1:400:75, about 1:450:75, about 1:500:75, about 1:50:77, about 1:100:77, about 1:130:77, about 1:131:77, about 1:132:77, about 1:133:77, about 1:134:77, about 1:135:77, about 1:136:77, about 1:137:77, about 1:138:77, about 1:139:77, about 1:140:77, about 1:150:77, about 1:200:77, about 1:250:77, about 1:300:77, about 1:350:77, about 1:400:77, about 1:450:77, about 1:500:77, or any combination thereof.

An eleventh embodiment includes the composition according to any one of the first to the tenth embodiments, wherein the second herbicide in the composition is 2,4-D DMA, and the third herbicide is glufosinate or an agriculturally acceptable salts thereof, wherein the weight ratio of the compound of formula (I) or an agriculturally acceptable salts, esters, and amides thereof to 2,4-D DMA to glufosinate or an agriculturally acceptable salts thereof given in units of gai/ha to gai/ha or gae/ha to gae/ha comprises from about 1:1000:500 to about 1:1:1, from about 1:500:500 to about 1:1:1, from about 1:400:400 to about 1:1:1, from about 1:1000:500 to about 1:130:70, from about 1:500:500 to about 1:130:70, from about 1:400:400 to about 1:130:70, from about 1:400:400 to about 1:12:1, from about 1:400:400 to about 1:12.5:1.8, from about 1:400:70 to about 1:25:2, from about 1:400:300 to about 1:50:4, from about 1:300:300 to about 1:1:1, from about 1:200:200 to about 1:1:1, from about 1:100:100 to about 1:1:1, from about 1:90:70 to about 1:1:1, from about 1:80:70 to about 1:1:1, from about 1:70:70 to about 1:1:1, from about 1:60:60 to about 1:1:1, from about 1:50:50 to about 1:1:1, from about 1:40:40 to about 1:1:1, from about 1:30:30 to about 1:1:1, from about 1:25:25 to about 1:1:1, from about 1:20:20 to about 1:1:1, from about 1:13:13 to about 1:1:1, from about 1:12.5:12.5 to about 1:1:1, from about 1:10:10 to about 1:1:1, from about 1:9:9 to about 1:1:1, from about 1:8:8 to about 1:1:1, from about 1:7:7 to about 1:1:1, from about 1:6:6 to about 1:1:1, from about 1:5:5 to about 1:1:1, from about 1:2:2 to about 1:1:1, from about 1:1:1 to about 1:1:1, about 1:1:1, about 1:2:2, about 1:4:4, about 1:5:5, about 1:10:10, about 1:12.5:12.5, about 1:25:25, about 1:50:50, about 1:100:100, about 1:150:150 about 1:200:200, about 1:250:250, about 1:300:300, about 1:350:350, about 1:400:400, about 1:450:450, about 1:500:500, about 1:50:70, about 1:100:70, about 1:130:70, about 1:131:70, about 1:132:70, about 1:133:70, about 1:134:70, about 1:135:70, about 1:136:70, about 1:137:70, about 1:138:70, about 1:139:70, about 1:140:70, about 1:150:70, about 1:200:70, about 1:250:70, about 1:300:70, about 1:350:70, about 1:400:70, about 1:450:70, about 1:500:70, about 1:50:75, about 1:100:75, about 1:130:75, about 1:131:75, about 1:132:75, about 1:133:75, about 1:134:75, about 1:135:75, about 1:136:75, about 1:137:75, about 1:138:75, about 1:139:75, about 1:140:75, about 1:150:75, about 1:200:75, about 1:250:75, about 1:300:75, about 1:350:75, about 1:400:75, about 1:450:75, about 1:500:75, about 1:50:77, about 1:100:77, about 1:130:77, about 1:131:77, about 1:132:77, about 1:133:77, about 1:134:77, about 1:135:77, about 1:136:77, about 1:137:77, about 1:138:77, about 1:139:77, about 1:140:77, about 1:150:77, about 1:200:77, about 1:250:77, about 1:300:77, about 1:350:77, about 1:400:77, about 1:450:77, about 1:500:77, or any combination thereof.

A twelfth embodiment includes the composition according to any one of the first to the eleventh embodiments, wherein the compound of Formula (I) in the composition is halauxifen-methyl, the second herbicide in the composition is 2,4-D DMA, and the third herbicide is glufosinate-ammonium, wherein the weight ratio of halauxifen-methyl to 2,4-D DMA to glufosinate-ammonium given in units of gai/ha to gai/ha or gae/ha to gae/ha comprises from about 1:1000:500 to about 1:1:1, from about 1:500:500 to about 1:1:1, from about 1:400:400 to about 1:1:1, from about 1:1000:500 to about 1:130:70, from about 1:500:500 to about 1:130:70, from about 1:400:400 to about 1:130:70, from about 1:400:400 to about 1:12:1, from about 1:400:400 to about 1:12.5:1.8, from about 1:400:70 to about 1:25:2, from about 1:400:300 to about 1:50:4, from about 1:300:300 to about 1:1:1, from about 1:200:200 to about 1:1:1, from about 1:100:100 to about 1:1:1, from about 1:90:70 to about 1:1:1, from about 1:80:70 to about 1:1:1, from about 1:70:70 to about 1:1:1, from about 1:60:60 to about 1:1:1, from about 1:50:50 to about 1:1:1, from about 1:40:40 to about 1:1:1, from about 1:30:30 to about 1:1:1, from about 1:25:25 to about 1:1:1, from about 1:20:20 to about 1:1:1, from about 1:13:13 to about 1:1:1, from about 1:12.5:12.5 to about 1:1:1, from about 1:10:10 to about 1:1:1, from about 1:9:9 to about 1:1:1, from about 1:8:8 to about 1:1:1, from about 1:7:7 to about 1:1:1, from about 1:6:6 to about 1:1:1, from about 1:5:5 to about 1:1:1, from about 1:2:2 to about 1:1:1, from about 1:1:1 to about 1:1:1, about 1:1:1, about 1:2:2, about 1:4:4, about 1:5:5, about 1:10:10, about 1:12.5:12.5, about 1:25:25, about 1:50:50, about 1:100:100, about 1:150:150 about 1:200:200, about 1:250:250, about 1:300:300, about 1:350:350, about 1:400:400, about 1:450:450, about 1:500:500, about 1:50:70, about 1:100:70, about 1:130:70, about 1:131:70, about 1:132:70, about 1:133:70, about 1:134:70, about 1:135:70, about 1:136:70, about 1:137:70, about 1:138:70, about 1:139:70, about 1:140:70, about 1:150:70, about 1:200:70, about 1:250:70, about 1:300:70, about 1:350:70, about 1:400:70, about 1:450:70, about 1:500:70, about 1:50:75, about 1:100:75, about 1:130:75, about 1:131:75, about 1:132:75, about 1:133:75, about 1:134:75, about 1:135:75, about 1:136:75, about 1:137:75, about 1:138:75, about 1:139:75, about 1:140:75, about 1:150:75, about 1:200:75, about 1:250:75, about 1:300:75, about 1:350:75, about 1:400:75, about 1:450:75, about 1:500:75, about 1:50:77, about 1:100:77, about 1:130:77, about 1:131:77, about 1:132:77, about 1:133:77, about 1:134:77, about 1:135:77, about 1:136:77, about 1:137:77, about 1:138:77, about 1:139:77, about 1:140:77, about 1:150:77, about 1:200:77, about 1:250:77, about 1:300:77, about 1:350:77, about 1:400:77, about 1:450:77, about 1:500:77, or any combination thereof.

A thirteenth embodiment includes the composition according to any one of the first to the twelfth embodiments, wherein the compound of Formula (I) is halauxifen-methyl, the second herbicide is 2,4-D DMA, and the third herbicide is glufosinate or an agriculturally acceptable salts, esters, and amides thereof.

A fourteenth embodiment includes the composition according to any one of the first to the thirteenth embodiments, wherein the composition further comprises at least one an agriculturally acceptable agent comprising an adjuvant, a carrier, and/or a safener.

A fifteenth embodiment includes the composition according to any one of the first to the fourteenth embodiments, the composition further comprises at least one additional herbicide.

An sixteenth embodiment includes a method of controlling undesirable vegetation comprising the step of applying or otherwise contacting vegetation and/or soil, and/or water with a herbicidally effective amount of at least one composition according to any one of the first to the fifteenth embodiments.

A seventeenth embodiment includes the method according to the sixteenth embodiment, wherein the method is practiced in at least one member of the group consisting of: direct-seeded, water-seeded, and/or transplanted rice, cereals, wheat, barley, oats, rye, sorghum, corn/maize, sugarcane, sunflower, oilseed rape, canola, sugarbeet, soybean, cotton, pineapple, pastures, grasslands, rangelands, fallowland, turf, tree and vine orchards, aquatics, plantation crops, vegetables, industrial vegetation management (IVM), or rights-of-way (ROW).

An eighteenth embodiment includes the method according to the sixteenth and/or seventeenth embodiments, wherein a herbicidally effective amount of the composition is applied either pre- or post-emergently to at least one of the following: a crop, a field, a ROW, or a rice paddy.

A nineteenth embodiment includes the method according to any one of the sixteenth to the eighteenth embodiments, wherein the undesirable vegetation may be controlled in: glyphosate-, 5-enolpyruvylshikimate-3-phosphate (EPSP) synthase inhibitor-, glufosinate-, glutamine synthetase inhibitor-, dicamba-, phenoxy auxin-, pyridyloxy auxin-, synthetic auxin-, auxin transport inhibitor-, aryloxyphenoxypropionate-, cyclohexanedione-, phenylpyrazoline-, acetyl CoA carboxylase (ACCase) inhibitor-, imidazolinone-, sulfonylurea-, pyrimidinylthiobenzoate-, triazolopyrimidine-, sulfonylaminocarbonyltriazolinone-, acetolactate synthase (ALS) or acetohydroxy acid synthase (AHAS) inhibitor-, 4-hydroxyphenyl-pyruvate dioxygenase (HPPD) inhibitor-, phytoene desaturase inhibitor-, carotenoid biosynthesis inhibitor-, protoporphyrinogen oxidase (PPO) inhibitor-, cellulose biosynthesis inhibitor-, mitosis inhibitor-, microtubule inhibitor-, very long chain fatty acid inhibitor-, fatty acid and lipid biosynthesis inhibitor-, photosystem I inhibitor-, photosystem II inhibitor-, protoporphyrinogen oxidase (PPO) inhibitor-, triazine-, or bromoxynil-tolerant crops.

A twentieth embodiment includes the method according to any one of the sixteenth to the nineteenth embodiments, wherein a plant that is resistant or tolerant to at least one herbicide is treated, and where the resistant tolerant crop possesses multiple or stacked traits conferring tolerance to multiple herbicides or inhibitors of multiple modes of action, in some embodiments the treated plant that expresses resistance or tolerance to a herbicide is a itself undesirable vegetation.

A twenty first embodiment includes the method according to any one of the sixteenth to the twentieth embodiments, wherein the resistant or tolerant weed is a biotype with resistance or tolerance to multiple herbicides, multiple chemical classes, inhibitors of multiple herbicide modes-of-action, or via multiple resistance mechanisms.

A twenty second embodiment includes the method according to any one of the sixteenth to the twenty first embodiments, wherein the resistant or tolerant undesirable plant is a biotype resistant or tolerant to at least one or more modes of action consisting of: acetolactate synthase (ALS) inhibitors or acetohydroxy acid synthase (AHAS) inhibitors, photosystem II inhibitors, acetyl CoA carboxylase (ACCase) inhibitors, synthetic auxins, auxin transport inhibitors, photosystem I inhibitors, 5-enolpyruvylshikimate-3-phosphate (EPSP) synthase inhibitors, microtubule assembly inhibitors, fatty acid and lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall, or organoarsenicals.

A twenty third embodiment includes a method of controlling undesirable vegetation comprising the step of applying a herbicidally effective amount of at least one compound according to any one of the first to the fifteenth embodiments, wherein the amount of the composition is applied at a rate, expressed in gai/ha or gae/ha of Formula (I) or an agriculturally acceptable salts, esters, and amides thereof comprises about: 1, 2, 3, 4, 4.1, 4.2, 4.3, 4.4, 4.5, 4.6, 4.7, 4.8, 4.9, 5, 6, 7, 8, 9, 10, 20, 30, 40, 50 gai/ha or gae/ha, or any combination thereof.

A twenty fourth embodiment includes the method according to the twenty third embodiment, wherein the amount of the composition is applied at a rate, expressed in gai/ha or gae/ha of at least one compound selected from the group consisting of: 2,4-D, 2,4-D EHE, 2,4-D DMA, 2,4-D choline, and 2,4-DB comprises about: 1, 5, 10, 25, 50, 100, 150, 200, 250, 300, 350, 400, 450, 500, 600, 610, 620, 630, 640, 650, 651, 652, 653, 654, 655, 656, 657, 658, 659, 660, 670, 680, 690, 700, 800, 900, and 1000 gai/ha or gae/ha, or any combination thereof.

A twenty fifth embodiment includes the method according to the twenty third and/or the twenty fourth embodiments, wherein the amount of the composition is applied at a rate, expressed in gai/ha or gae/ha of halauxifen-methyl and 2,4-D DMA comprises about: 100, 200, 300, 400, 500, 600, 610, 620, 630, 640, 650, 651, 652, 653, 654, 655, 656, 657, 658, 659, 660, 670, 680, 690, 700, 800, 900, and 1000 gai/ha or gae/ha, or any combination thereof.

A twenty sixth embodiment includes the method according to the twenty third and/or the twenty fifth embodiments, wherein the amount of the composition is applied at a rate, expressed in gai/ha or gae/ha of glufosinate or an agriculturally acceptable salts, esters, and amides thereof comprises about: 100, 200, 300, 350, 360, 361, 362, 363, 364, 365, 366, 367, 368, 369, 370. 380, 390, 400, 450, 500, 600, 700, 800, 900, and 1000, or any combination thereof.

A twenty seventh embodiment includes the method according to any one of the sixteenth to the twenty sixth embodiments, wherein the controlled plant is at least one plant comprising at least one Conyza species. Consistent with these embodiments, the at least one Conyza species include, but are not limited to, Conyza sumatrensis (Sumatran fleabane, ERISU), Conyza canadensis (Canadian fleabane, ERICA), Conyza bonariensis (hairy fleabane, ERIBO) or other related fleabane species (Conyza spp, ERISS).

A twenty eighth embodiment includes a method of controlling undesirable vegetation which includes contacting the vegetation or locus thereof with or applying to the soil or water to prevent the emergence of growth of vegetation the composition according to any one of the first to the fifteenth embodiments.

A twenty ninth embodiment includes the method according to any one of the sixteenth to the twenty eighth embodiments, wherein the undesirable vegetation is immature.

A thirtieth embodiment includes the method according to any one of the sixteenth to the twenty ninth embodiments, wherein the composition according to any one of the first to the eighteenth embodiments are applied to water.

A thirty first embodiment includes the method according to any one of the sixteenth to the thirtieth embodiments, wherein the composition according to any one of the first to the fifteenth embodiments are applied pre-emergently to a crop or growing area.

A thirty second embodiment includes the method according to any one of the sixteenth to the thirty first embodiments, wherein the composition according to any one of the first to the eighteenth embodiments are applied post-emergently to a crop or growing area.

A thirty third embodiment includes the method according to any one of the sixteenth to the thirty second embodiments, wherein the tolerant crop possesses multiple or stacked traits conferring tolerance to multiple herbicides or multiple modes of action.

A thirty fourth embodiment includes the method according to any one of the sixteenth to the thirty third embodiments, wherein the composition according to any one of the first to the fifteenth embodiments are applied for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 and/or 50 days.

A thirty fifth embodiment includes the method according to any one of the sixteenth to the thirty fourth embodiments, wherein the composition according to any one of the first to the fifteenth embodiments are applied for at least 1, 2, 3, 4, 5, 6, 7, 8, 9, 10, 11, 12, 13, 14, 15, 16, 17, 18, 19, 20, 21, 22, 23, 24, 25, 26, 27, and/or 28 days.

A thirty sixth embodiment includes the method according to any one of the sixteenth to the thirty fifth embodiments, wherein the composition according to any one of the first to the fifteenth embodiments are applied for at least 1, 2, 3, 4, 5, 6, 7, 8, 9, 10, 11, 12, 13, 14, 15, 16, and/or 17 days.

### DETAILED DESCRIPTION

While the concepts of the present disclosure are illustrated and described in detail in the figures and the description herein, results in the figures and their description are to be considered as exemplary and not restrictive in character; it being understood that only the illustrative embodiments are shown and described and that all changes and modifications that come within the spirit of the disclosure are desired to be protected.

### Definitions

Unless defined otherwise, the scientific and technology nomenclatures have the same meaning as commonly understood by a person in the ordinary skill in the art pertaining to this disclosure.

As used herein, unless explicitly stated otherwise or clearly implied otherwise the term ‘about’ refers to a range of values plus or minus 10 percent, e.g. about 1.0 encompasses values from 0.9 to 1.1.

As used herein, the compound of Formula (I) has the following structure:

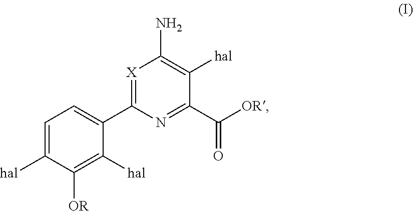

wherein X represents CH or N, hal represents F, Cl or Br, R represents methyl or ethyl, and R′ represents H, methyl or ethyl, or an agriculturally acceptable salts, esters, and amides thereof. Unless explicitly stated otherwise or clearly implied otherwise, a compound of Formula (I) can include, but is not limited to, halauxifen or halauxifen-methyl.

As used herein, halauxifen-methyl (methyl 4-amino-3-chloro-6-(4-chloro-2-fluoro-3-methoxyphenyl)picolinate) possesses the following structure:

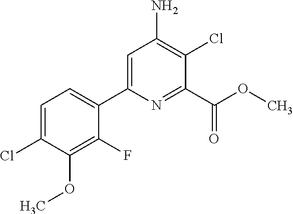 [SMILES: COC(=O)c1nc(-c2ccc(Cl)c(OC)c2F)cc(N)c1Cl]

It is described in in U.S. Pat. No. 7,314,849 B2, which is incorporated herein by reference in its entirety. Exemplary uses of halauxifen-methyl include its use to control broadleaf weeds, e.g., in cereal crops. Halauxifen-methyl may be used as other forms, e.g., halauxifen K+(potassium 4-amino-3-chloro-6-(4-chloro-2-fluoro-3-methoxyphenyl) picolinate), which possesses the following structure:

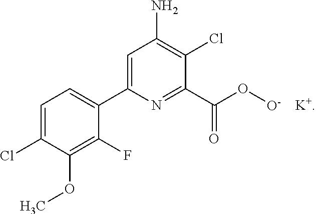 [SMILES: COc1c(Cl)ccc(-c2cc(N)c(Cl)c(C(=O)O[O-])n2)c1F]

As used herein, pyridine or pyrimidine carboxylic acids of Formula (I) can include 4-Amino-3-chloro-6-(4-chloro-2-fluoro-3-methoxyphenyl)pyridine-2-carboxylic acid and 6-amino-5-chloro-2-(4-chloro-2-fluoro-3-methoxyphenyl)-pyrimidine-4-carboxylic acid derivatives can pyridine or pyrimidine carboxylic acids of Formula (I). Exemplary uses of the compound of the Formula (I) include controlling undesirable vegetation, including but not limited to grass, broadleaf and sedge weeds, in multiple non-crop and cropping situations.

As used herein, 2,4-D is 2-(2,4-dichlorophenoxy)acetic acid and possesses the following structure:

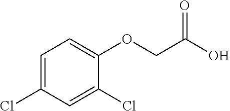 [SMILES: O=C(O)COc1ccc(Cl)cc1Cl]

Exemplary uses of 2,4-D are described in Tomlin, C., ed. A World Compendium The Pesticide Manual. 15th ed. Alton: BCPC Publications, 2009 (hereafter “The Pesticide Manual, Fifteenth Edition, 2009.”). Exemplary uses of 2,4-D include its use for post-emergence control of annual and perennial broadleaf weeds, e.g., in cereals, maize, sorghum, grassland, established turf, grass seed crops, orchards, cranberries, asparagus, sugar cane, rice forestry and non-crop land. Exemplary chemical forms of 2,4-D include salt or ester forms, for example, 2,4-D EHE, which is 2-ethylhexyl 2-(2,4-dichlorophenoxy)acetate and possesses the following structure:

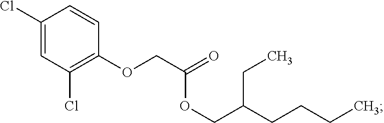 [SMILES: CCCCC(CC)COC(=O)COc1ccc(Cl)cc1Cl]

2,4-D DMA, which is 2-(2,4-dichlorophenoxy)acetic acid with N-methylmethanamine and possesses the following structure:

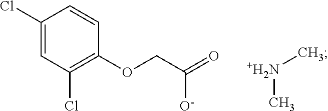

2,4-D choline, which is 2-hydroxy-N,N,N-trimethylethanaminium 2-(2,4-dichlorophenoxy)acetate and possesses the following structure:

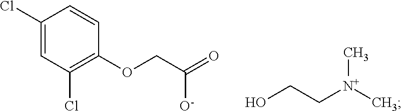

and

2,4-DB, which is 2-(2,4-dichlorophenoxy)butyric acid and possesses the following structure:

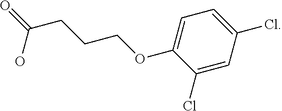 [SMILES: O=C(O)CCCOc1ccc(Cl)cc1Cl]

As used herein, glufosinate is 2-amino-4-[hydroxy(methyl)phosphinoyl]butyric acid. An exemplary form of glufosinate is glufosinate-ammonium, the ammonium salt of glufosinate. It can be referred to as 2-amino-4-(hydroxymethylphosphinyl) butanoic acid monoammonium salt and possesses the following structure:

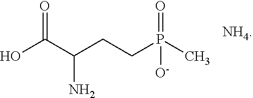

Other chemical forms of glufosinate (or phosphinothricin) include bialaphos, which is 2-amino-4-(methylphosphino) butyrylalanylalanine and possesses the following structure:

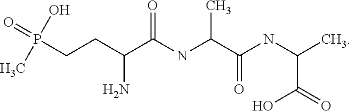 [SMILES: CC(NC(=O)C(C)NC(=O)C(N)CCP(C)(=O)O)C(=O)O]

Bialaphos also can be used in the salt form such as bialaphos sodium. Exemplary uses are described in Tomlin, C., and ed. A World Compendium The Pesticide Manual. 15^{th} ed. Alton: BCPC Publications, 2009 (hereafter “The Pesticide Manual, Fifteenth Edition, 2009.”). Exemplary uses include its use to control annual and perennial broadleaf weeds and grasses. Other chemical forms include glufosinate-P, i.e., S-2-amino-4-[hydroxy(methyl)phosphinoyl]butyric acid.

As used herein, herbicide means a compound, e.g., an active ingredient that kills, controls or otherwise adversely modifies the growth of plants.

As used herein, a herbicidally effective or vegetation controlling amount is an amount of active ingredient which causes an adversely modifying effect to the vegetation e.g., causing deviations from natural development, killing, effecting regulation, causing desiccation, causing retardation, and the like.

As used herein, controlling undesirable vegetation means preventing, reducing, killing, or otherwise adversely modifying the development of plants and vegetation. Described herein are methods of controlling undesirable vegetation through the application of certain herbicide combinations or compositions. Methods of application include, but are not limited to applications to the vegetation or locus thereof, e.g., application to the area adjacent to the vegetation, as well as preemergence, postemergence, foliar (broadcast, directed, banded, spot, mechanical, over-the-top, or rescue), and in-water applications (emerged and submerged vegetation, broadcast, spot, mechanical, water-injected, granular broadcast, granular spot, shaker bottle, or stream spray) via hand, backpack, machine, tractor, or aerial (airplane and helicopter) application methods.

As used herein, plants and vegetation include, but are not limited to, germinant seeds, emerging seedlings, plants emerging from vegetative propagules, immature vegetation, and established vegetation.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

Exemplary salts include those derived from alkali or alkaline earth metals and those derived from ammonia and amines. Exemplary cations include sodium, potassium, magnesium, and ammonium cations of the formula:

R¹R²R³R⁴N⁺

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment with a metal hydroxide, such as sodium hydroxide, with an amine, such as ammonia, trimethylamine, diethanolamine, 2-methylthiopropylamine, bisallylamine, 2-butoxyethylamine, morpholine, cyclododecylamine, or benzylamine or with a tetraalkylammonium hydroxide, such as tetramethylammonium hydroxide or choline hydroxide.

Exemplary esters include those derived from C1-C12 alkyl, C3-C12 alkenyl, C3-C12 alkynyl or C7-C10 aryl-substituted alkyl alcohols, such as methyl alcohol, isopropyl alcohol, 1-butanol, 2-ethylhexanol, butoxyethanol, methoxypropanol, allyl alcohol, propargyl alcohol, cyclohexanol or unsubstituted or substituted benzyl alcohols. Benzyl alcohols may be substituted with from 1-3 substituents independently selected from halogen, C1-C4 alkyl or C1-C4 alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

### Compositions and Methods

Provided herein are herbicidal compositions comprising a herbicidally effective amount of (a) a compound of Formula (I):

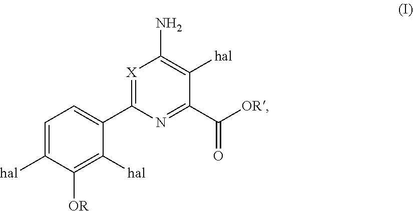

wherein X represents CH or N, hal represents F, Cl or Br, R represents methyl or ethyl, and R′ represents H, methyl or ethyl, or an agriculturally acceptable salt or ester thereof; (b) a second herbicide comprising at least one phenoxy herbicide, or an agriculturally acceptable salts, esters, and amides thereof; and/or (c) a third herbicide comprising at least one organophosphorus herbicide, or an agriculturally acceptable salts, esters, and amides thereof.

Provided herein are also methods of controlling undesirable vegetation comprising contacting the vegetation or the locus thereof, i.e., area adjacent to the vegetation, with or applying to the soil or water to prevent the emergence or growth of vegetation a herbicidally effective amount of the compound of Formula (I) or agriculturally acceptable salt or ester thereof; (b) a second herbicide comprising at least one phenoxy herbicide, or an agriculturally acceptable salts, esters, and amides thereof; and/or (c) a third herbicide comprising at least one organophosphorus herbicide, or an agriculturally acceptable salts, esters, and amides thereof. In certain embodiments, the methods employ the compositions described herein.

Furthermore, in some embodiments, the combination of a compound of Formula (I) or agriculturally acceptable salt or ester thereof, a second herbicide comprising at least one phenoxy herbicide, or an agriculturally acceptable salts, esters, and amides thereof; and/or a third herbicide comprising at least one organophosphorus herbicide, or an agriculturally acceptable salts, esters, and amides thereof is more effective in combination than when applied individually.

In certain embodiments of the compositions and methods described herein, the compound of Formula (I), i.e., halauxifen methyl, is employed. In certain embodiments, a carboxylate salt of the compound of Formula (I) is employed. In certain embodiments, an aralkyl or alkyl ester is employed. In certain embodiments, a benzyl, substituted benzyl, or C1-4 alkyl, e.g., n-butyl ester is employed. In certain embodiments, the benzyl ester is employed.

In some embodiments, the compound of formula (I) or salt or ester thereof, a second herbicide comprising at least one phenoxy herbicide, or an agriculturally acceptable salts, esters, and amides thereof; and/or a third herbicide comprising at least one organophosphorus herbicide, or an agriculturally acceptable salts, esters, and amides thereof are formulated in one composition, tank mixed, applied simultaneously, or applied sequentially.

Herbicidal activity is exhibited by the compounds when they are applied directly to the plant or to the locus of the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. In some embodiments, the compositions described herein are applied as a post-emergence application, pre-emergence application, or in-water application to flooded paddy rice or water bodies (e.g., ponds, lakes and streams), to relatively immature undesirable vegetation to achieve the maximum control of weeds.

In some embodiments, the compositions and methods provided herein are utilized to control weeds in crops, including but not limited to direct-seeded, water-seeded and transplanted rice, cereals, wheat, barley, oats, rye, sorghum, corn/maize, sugarcane, sunflower, oilseed rape, canola, sugarbeet, soybean, cotton, pineapple, pastures, grasslands, rangelands, fallowland, turf, tree and vine orchards, aquatics, plantation crops, vegetables, industrial vegetation management (IVM) and rights of way (ROW).

The compositions and methods described herein may be used to control undesirable vegetation in glyphosate-tolerant-, 5-enolpyruvylshikimate-3-phosphate (EPSP) synthase inhibitor-tolerant-, glufosinate-tolerant-, glutamine synthetase inhibitor-tolerant-, dicamba-tolerant-, phenoxy auxin-tolerant-, pyridyloxy auxin-tolerant-, auxin-tolerant-, auxin transport inhibitor-tolerant-, aryloxyphenoxypropionate-tolerant-, cyclohexanedione-tolerant-, phenylpyrazoline-tolerant-, acetyl CoA carboxylase (ACCase) inhibitor-tolerant-, imidazolinone-tolerant-, sulfonylurea-tolerant-, pyrimidinylthiobenzoate-tolerant-, triazolopyrimidine-tolerant-, sulfonylaminocarbonyltriazolinone-tolerant-, acetolactate synthase (ALS) or acetohydroxy acid synthase (AHAS) inhibitor-tolerant-, 4-hydroxyphenyl-pyruvate dioxygenase (HPPD) inhibitor-tolerant-, phytoene desaturase inhibitor-tolerant-, carotenoid biosynthesis inhibitor-tolerant-, protoporphyrinogen oxidase (PPO) inhibitor-tolerant-, cellulose biosynthesis inhibitor-tolerant-, mitosis inhibitor-tolerant-, microtubule inhibitor-tolerant-, very long chain fatty acid inhibitor-tolerant-, fatty acid and lipid biosynthesis inhibitor-tolerant-, photosystem I inhibitor-tolerant-, photosystem II inhibitor-tolerant-, triazine-tolerant- and bromoxynil-tolerant-crops (such as, but not limited to, soybean, cotton, canola/oilseed rape, rice, cereals, corn, sorghum, sunflower, sugarbeet, sugarcane, turf, etc.), for example, in conjunction with glyphosate, EPSP synthase inhibitors, glufosinate, glutamine synthase inhibitors, dicamba, phenoxy auxins, pyridyloxy auxins, synthetic auxins, auxin transport inhibitors, aryloxyphenoxypropionates, cyclohexanediones, phenylpyrazolines, ACCase inhibitors, imidazolinones, sulfonylureas, pyrimidinylthiobenzoates, triazolopyrimidines, sulfonylaminocarbonyltriazolinones, ALS or AHAS inhibitors, HPPD inhibitors, phytoene desaturase inhibitors, carotenoid biosynthesis inhibitors, PPO inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil. The compositions and methods may be used in controlling undesirable vegetation in crops possessing multiple or stacked traits conferring tolerance to multiple chemistries and/or inhibitors of multiple modes of action. In some embodiments, the compound of formula (I) or salt or ester thereof and complementary herbicide or salt or ester thereof are used in combination with herbicides that are selective for the crop being treated and which complement the spectrum of weeds controlled by these compounds at the application rate employed. In some embodiments, the compositions described herein and other complementary herbicides are applied at the same time, either as a combination formulation, as a tank mix or sequentially.

The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

The compositions and methods provided herein are utilized to control undesirable vegetation. Undesirable vegetation includes, but is not limited to, undesirable vegetation that occurs in rice, cereals, wheat, barley, oats, rye, pastures, grasslands, rangelands, fallowland, row crops (e.g., corn/maize, sugarcane, sunflower, oilseed rape, canola, sugarbeet, soybean, cotton), turf, trees and vine orchards, plantation crops, vegetables, ornamental species, aquatic or non-crop settings, (e.g., rights-of-way, industrial vegetation management).

In some embodiments, the methods provided herein are utilized to control undesirable vegetation in rice. In certain embodiments, the undesirable vegetation is Brachiaria platyphylla (Groseb.) Nash or Urochloa platyphylla (Nash) R. D. Webster (broadleaf signalgrass, BRAPP), Digitaria sanguinalis (L.) Scop. (large crabgrass, DIGSA), Echinochloa species (ECHSS), Echinochloa crus-galli (L.) P. Beauv. (barnyardgrass, ECHCG), Echinochloa crus-pavonis (Kunth) Schult. (gulf cockspur, ECHCV), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Echinochloa phyllopogon (Stapf) Koso-Pol. (rice barnyardgrass, ECHPH), Echinochloa polystachya (Kunth) Hitchc. (creeping river grass, ECHPO), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Oryza species (red and weedy rice, ORYSS), Panicum dichotomiflorum (L.) Michx. (fall panicum, PANDI), Paspalum dilatatum Poir. (dallisgrass, PASDI), Rottboellia cochinchinensis (Lour.) W. D. Clayton (itchgrass, ROOEX), Cyperus species (CYPSS), Cyperus difformis L. (smallflower flatsedge, CYPDI), Cyperus dubius Rottb. (MAPDU), Cyperus esculentus L. (yellow nutsedge, CYPES), Cyperus iria L. (rice flatsedge, CYPIR), Cyperus rotundus L. (purple nutsedge, CYPRO), Cyperus serotinus Rottb./C. B. Clarke (tidalmarsh flatsedge, CYPSE), Eleocharis species (ELOSS), Fimbristylis miliacea (L.) Vahl (globe fringerush, FIMMI), Schoenoplectus species (SCPSS), Schoenoplectus juncoides Roxb. (Japanese bulrush, SCPJU), Bolboschoenus maritimus (L.) Palla or Schoenoplectus maritimus L. Lye (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Commelina benghalensis L. (Benghal dayflower, COMBE), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea species (morningglories, IPOSS), Ipomoea hederacea (L.) Jacq. (ivyleaf morningglory, IPOHE), Lindernia dubia (L.) Pennell (low false pimpernel, LIDDU), Ludwigia species (LUDSS), Ludwigia linifolia Poir. (southeastern primrose-willow, LUDLI), Ludwigia octovalvis (Jacq.) Raven (longfruited primrose-willow, LUDOC), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (POLHP, mild smartweed), Rotala indica (Willd.) Koehne (Indian toothcup, ROTIN), Sagittaria species, (arrowhead, SAGSS), Sesbania exaltata (Raf) Cory/Rydb. Ex Hill (hemp sesbania, SEBEX), or Sphenoclea zeylanica Gaertn. (gooseweed, SPDZE).

In some embodiments, the methods provided herein are utilized to control undesirable vegetation in cereals. In certain embodiments, the undesirable vegetation is Alopecurus myosuroides Huds. (blackgrass, ALOMY), Apera spica-venti (L.) Beauv. (windgrass, APESV), Avena fatua L. (wild oat, AVEFA), Bromus tectorum L. (downy brome, BROTE), Lolium multiflorum Lam. (Italian ryegrass, LOLMU), Phalaris minor Retz. (littleseed canarygrass, PHAMI), Poa annua L. (annual bluegrass, POANN), Setaria pumila (Poir.) Roemer & J. A. Schultes (yellow foxtail, SETLU), Setaria viridis (L.) Beauv. (green foxtail, SETVI), Amaranthus retroflexus L. (redroot pigweed, AMARE), Brassica species (BRSSS), Chenopodium album L. (common lambsquarters, CHEAL), Cirsium arvense (L.) Scop. (Canada thistle, CIRAR), Galium aparine L. (catchweed bedstraw, GALAP), Kochia scoparia (L.) Schrad. (kochia, KCHSC), Lamium purpureum L. (purple deadnettle, LAMPU), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Sinapis species (SINSS), Sinapis arvensis L. (wild mustard, SINAR), Stellaria media (L.) Vill. (common chickweed, STEME), Veronica persica Poir. (Persian speedwell, VERPE), Viola arvensis Mum (field violet, VIOAR), or Viola tricolor L. (wild violet, VIOTR).

In some embodiments, the methods provided herein are utilized to control undesirable vegetation in range and pasture, fallowland, IVM and ROW. In certain embodiments, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Daucus carota L. (wild carrot, DAUCA), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G. H. Weber ex Wiggers (dandelion, TAROF), Trifolium repens L. (white clover, TRFRE), or Urtica dioica L. (common nettle, URTDI).

In some embodiments, the methods provided herein are utilized to control undesirable vegetation found in row crops, tree and vine crops, and perennial crops. In certain embodiments, the undesirable vegetation is Alopecurus myosuroides Huds. (blackgrass, ALOMY), Avena fatua L. (wild oat, AVEFA), Brachiaria decumbens Stapf or Urochloa decumbens (Stapf) R. D. Webster (Surinam grass, BRADC), Brachiaria brizantha (Hochst. ex A. Rich.) Stapf. or Urochloa brizantha (Hochst. ex A. Rich.) R.D. (beard grass, BRABR), Brachiaria platyphylla (Groseb.) Nash or Urochloa platyphylla (Nash) R.D. Webster (broadleaf signalgrass, BRAPP), Brachiaria plantaginea (Link) Hitchc. or Urochloa plantaginea (Link) R. D. Webster (alexandergrass, BRAPL), Cenchrus echinatus L. (southern sandbur, CENEC), Digitaria horizontalis Willd. (Jamaican crabgrass, DIGHO), Digitaria insularis (L.) Mez ex Ekman (sourgrass, TRCIN), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Eleusine indica (L.) Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Anoda cristata (L.) Schlecht. (spurred anoda, ANVCR), Asclepias syriaca L. (common milkweed, ASCSY), Bidens pilosa L. (hairy beggarticks, BIDPI), Borreria species (BOISS), Borreria alata (Aubl.) DC. or Spermacoce alata Aubl. (broadleaf buttonweed, BOILF), Spermacose latifolia (broadleaved button weed, BOILF), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Euphorbia hirta L. or Chamaesyce hirta (L.) Millsp. (garden spurge, EPHHI), Euphorbia dentata Michx. (toothed spurge, EPHDE), Erigeron bonariensis L. or Conyza bonariensis (L.) Cronq. (hairy fleabane, ERIBO), Erigeron sumatrensis or Conyza sumatrensis (Sumatran fleabane, ERISU), Erigeron canadensis L. or Conyza canadensis (Canadian fleabane, ERICA), or other related fleabane species (Conyza spp, ERISS), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Richardia species (pusley, RCHSS), Sida species (sida, SIDSS), Sida spinosa L. (prickly sida, SIDSP), Sinapis arvensis L. (wild mustard, SINAR), Solanum ptychanthum Dunal (eastern black nightshade, SOLPT), Tridax procumbens L. (coat buttons, TRQPR) or Xanthium strumarium L. (common cocklebur, XANST).

In some embodiments, the methods provided herein are utilized to control undesirable vegetation in turf. In certain embodiments, the undesirable vegetation is Bellis perennis L. (English daisy, BELPE), Cyperus esculentus L. (yellow nutsedge, CYPES), Cyperus species (CYPSS), Digitaria sanguinalis (L.) Scop. (large crabgrass, DIGSA), Diodia virginiana L. (Virginia buttonweed, DIQVI), Euphorbia species (spurge, EPHSS), Glechoma hederacea L. (ground ivy, GLEHE), Hydrocotyle umbellata L. (dollarweed, HYDUM), Kyllinga species (kyllinga, KYLSS), Lamium amplexicaule L. (henbit, LAMAM), Murdannia nudiflora (L.) Brenan (doveweed, MUDNU), Oxalis species (woodsorrel, OXASS), Plantago major L. (broadleaf plantain, PLAMA), Plantago lanceolata L. (buckhorn/narrowleaf plantain, PLALA), Phyllanthus urinaria L. (chamberbitter, PYLTE), Rumex obtusifolius L. (broadleaf dock, RUMOB), Stachys floridana Shuttlew. (Florida betony, STAFL), Stellaria media (L.) Vill. (common chickweed, STEME), Taraxacum officinale G. H. Weber ex Wiggers (dandelion, TAROF), Trifolium repens L. (white clover, TRFRE), or Viola species (wild violet, VIOSS).

In some embodiments, the compositions and methods provided herein are utilized to control undesirable vegetation, including grass, broadleaf and sedge weeds. In certain embodiments, the compositions and methods provided herein are utilized to control undesirable vegetation including but not limited to Alopecurus, Avena, Centaurea, Cyperus, Digitaria, Echinochloa, Ipomoea, Leptochloa and Sonchus.

In some embodiments, the combination of a compound of Formula (I) or agriculturally acceptable ester or salt thereof a second herbicide comprising at least one phenoxy herbicide, or an agriculturally acceptable salts, esters, and amides thereof; and/or a third herbicide comprising at least one organophosphorus herbicide, or an agriculturally acceptable salts, esters, and amides thereof is used to control at least one Conyza species including, but are not limited to, Conyza sumatrensis (Sumatran fleabane, ERISU), Conyza canadensis (Canadian fleabane, ERICA), Conyza bonariensis (hairy fleabane, ERIBO) or other related fleabane species (Conyza spp, ERISS).

The compounds of Formula (I) or agriculturally acceptable salt or ester thereof may be used to control herbicide resistant or tolerant weeds. The methods employing the combination of a compound of formula I or agriculturally acceptable salt or ester thereof and the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors, (e.g., imidazolinones, sulfonylureas, pyrimidinylthiobenzoates, triazolopyrimidines, and sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors, (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, ipfencarbazone, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 45100-03-7) and 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione; b5) from the group of the bleacher herbicides), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes-of-action, and biotypes with multiple resistance or tolerance mechanisms (e.g., target site resistance or metabolic resistance).

In certain embodiments of the compositions and methods described herein, the compound of Formula (I) or salt or ester thereof is used in combination with at least one compound selected from the group consisting of: 2,4-D, 2,4-D EHE, 2,4-D DMA, 2,4-D choline, and 2,4-DB. In some embodiments, the weight ratio of the compound of Formula (I) or salt or ester thereof to at least one compound selected from the group consisting of: 2,4-D, 2,4-D EHE, 2,4-D DMA, 2,4-D choline, and 2,4-DB is within the range of from about 1:500 to about 1:500. In certain embodiments, the weight ratio of the compound of Formula (I) or salt or ester thereof to at least one compound selected from the group consisting of: 2,4-D, 2,4-D EHE, 2,4-D DMA, 2,4-D choline, and 2,4-DB is within the range of from about 1:500 to about 1:1. In certain embodiments, the weight ratio of the compound of Formula (I) or salt or ester thereof to at least one compound selected from the group consisting of: 2,4-D, 2,4-D EHE, 2,4-D DMA, 2,4-D choline, and 2,4-DB is within the range of from about 1:200 to about 1:200. In certain embodiments, the compositions provided herein comprise the compound of Formula (I) or salt or ester thereof and 2,4-D or esters thereof. In one embodiment, the composition comprises the compound of Formula (I) or salt or ester thereof and 2,4-D DMA, wherein the weight ratio of the compound of Formula (I) or salt or ester thereof to 2,4-D DMA is from about 1:500 to about 1:500 or from about 1:400 to about 1:1. In one embodiment, the composition comprises the compound of Formula (I) or salt or ester thereof and 2,4-D DMA, wherein the weight ratio of the benzyl ester of the compound of Formula (I) or salt or ester thereof to 2,4-D DMA is from about 1:200 to about 1:200 or from about 1:200 to about 1:1.

With respect to the methods, in certain embodiments, the methods comprise contacting the undesirable vegetation or locus thereof or applying to the soil or water to prevent the emergence or growth of vegetation a composition described herein. In some embodiments, the composition is applied at an application rate of from about 1 gram active ingredient per hectare (gai/ha) to about 1000 grams active ingredient per hectare (gai/ha) based on the total amount of active ingredients in the composition. In certain embodiments, the composition is applied at an application rate of from about 4 grams acid equivalent per hectare (gae/ha) to about 1000 gae/ha based on the total amount of active ingredients in the composition. In some embodiments, the methods comprise contacting the undesirable vegetation or locus thereof or applying to the soil or water to prevent the emergence or growth of vegetation with a compound of Formula (I) or salt or ester thereof and at least one compound selected from the group consisting of: 2,4-D, 2,4-D EHE, 2,4-D DMA, 2,4-D choline, and 2,4-DB, e.g., sequentially or simultaneously. In some embodiments, the compound of Formula (I) or salt or ester thereof and the at least one compound selected from the group consisting of: 2,4-D, 2,4-D EHE, 2,4-D DMA, 2,4-D choline, and 2,4-DB are applied in combination at a rate from about 50 gai/ha to about 1000 gai/ha. In some embodiments, the compound of Formula (I) or salt or ester thereof and the at least one compound selected from the group consisting of: 2,4-D, 2,4-D EHE, 2,4-D DMA, 2,4-D choline, and 2,4-DB are applied in combination at a rate from about 100 gai/ha to about 800 gai/ha. In some embodiments, the compound of Formula (I) or salt or ester thereof and the at least one compound selected from the group consisting of: 2,4-D, 2,4-D EHE, 2,4-D DMA, 2,4-D choline, and 2,4-DB are applied in combination at a rate from about 200 gai/ha to about 700 gai/ha. In one embodiment, the methods utilize halauxifen-methyl and 2,4-D DMA, wherein the combination of halauxifen-methyl and 2,4-D DMA is applied at a rate of from about 200 gai/ha to about 700 gai/ha, about 300 gai/ha to about 700 gai/ha, about 400 gai/ha to about 700 gai/ha, about 500 gai/ha to about 700 gai/ha, about 600 gai/ha to about 700 gai/ha, about 650 gai/ha, about 655 gai/ha, about 670 gai/ha, or any combination thereof. In certain embodiments, the methods and compositions utilizing the compound of Formula (I) or salt or ester thereof in combination with at least one compound selected from the group consisting of: 2,4-D, 2,4-D EHE, 2,4-D DMA, 2,4-D choline, and 2,4-DB are used to control at least one Conyza species including, but are not limited to, Conyza sumatrensis (Sumatran fleabane, ERISU), Conyza canadensis (Canadian fleabane, ERICA), Conyza bonariensis (hairy fleabane, ERIBO) or other related fleabane species (Conyza spp, ERISS).

In certain embodiments of the compositions and methods described herein, the compound of Formula (I) or salt or ester thereof is used in combination with glufosinate or an agriculturally acceptable salts, esters, and amides thereof. In some embodiments, the weight ratio of the compound of Formula (I) or salt or ester thereof to glufosinate or an agriculturally acceptable salts, esters, and amides thereof is within the range of from about 1:500 to about 1:1. In certain embodiments, the weight ratio of the compound of Formula (I) or salt or ester thereof to glufosinate or an agriculturally acceptable salts, esters, and amides thereof is within the range of from about 1:400 to about 1:12.5. In certain embodiments, the weight ratio of the compound of Formula (I) or salt or ester thereof to glufosinate or an agriculturally acceptable salts, esters, and amides thereof is within the range of from about 1:200 to about 1:25. In certain embodiments, the compositions provided herein comprise the compound of Formula (I) or salt or ester thereof and glufosinate or its ammonium salt. In one embodiment, the composition comprises the compound of Formula (I) or salt or ester thereof and the glufosinate ammonium, wherein the weight ratio of the compound of Formula (I) or salt or ester thereof to the glufosinate ammonium is from about 1:400 to about 1:12.5 or from about 1:400 to about 1:25. In one embodiment, the composition comprises the compound of Formula (I) or salt or ester thereof and glufosinate ammonium, wherein the weight ratio of the benzyl ester of the compound of Formula (I) or salt or ester thereof to glufosinate ammonium is from about 1:200 to about 1:12.5 or from about 1:200 to about 1:25.

In some embodiments, the composition comprises a combination comprising halauxifen-methyl and 2,4-D DMA, and glufosinate-ammonium, wherein the weight ratio of the combination (halauxifen-methyl+2,4-D DMA) to glufosinate-ammonium is from about 100:1 to about 1:1, from about 100:1 to about 50:1, from about 100:1 to about 40:1, from about 100:1 to about 20:1, from about 100:1 to about 15:1, from about 100:1 to about 14:1, from about 100:1 to about 13:1, from about 100:1 to about 12:1, from about 100:1 to about 11:1, from about 100:1 to about 10:1, from about 100:1 to about 5:1, from about 100:1 to about 4:1, from about 100:1 to about 3:1, from about 100:1 to about 2:1, about 100:1, about 50:1, about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1.9:1, about 1.8:1, about 1.7:1, about 1.6:1, about 1.5:1, about 1:1, or any combination thereof. In one embodiment, wherein the weight ratio of the combination (halauxifen-methyl+2,4-D DMA) to glufosinate-ammonium is from about 30:1 to about 1.5:1 or from about 10:1 to about 1.8:1.

With respect to the methods, in certain embodiments, the methods comprise contacting the undesirable vegetation or locus thereof or applying to the soil or water to prevent the emergence or growth of vegetation a composition described herein. In some embodiments, the composition is applied at an application rate of from about 1 gram active ingredient per hectare (gai/ha) to about 500 grams gai/ha based on the total amount of active ingredients in the composition. In certain embodiments, the composition is applied at an application rate of from about 4 grams acid equivalent per hectare (gai/ha) to about 400 gai/ha based on the total amount of active ingredients in the composition. In some embodiments, the methods comprise contacting the undesirable vegetation or locus thereof or applying to the soil or water to prevent the emergence or growth of vegetation with a compound of Formula (I) or salt or ester thereof and glufosinate or an agriculturally acceptable salts, esters, and amides thereof or salt or ester thereof, e.g., sequentially or simultaneously. In some embodiments, the glufosinate or an agriculturally acceptable salts, esters, and amides thereof is applied at a rate from about 1 gai/ha to about 500 gai/ha and the compound of Formula (I) of salt or ester thereof is applied at a rate from about 1 gai/ha to about 4 gai/ha. In some embodiments, the glufosinate or an agriculturally acceptable salts, esters, and amides thereof is applied at a rate from about 50 gai/ha to about 500 gai/ha and the compound of Formula (I) of salt or ester thereof is applied at a rate from about 1 gai/ha to about 4 gai/ha. In some embodiments, the glufosinate or an agriculturally acceptable salts, esters, and amides thereof is applied at a rate from about 100 gai/ha to about 400 gai/ha and the compound of Formula (I) of salt or ester thereof is applied at a rate from about 1 gai/ha to about 4 gai/ha. In one embodiment, the methods utilize the compound of Formula (I) and glufosinate, wherein the compound of Formula (I) is applied at a rate of from about 1 gai/ha to about 4 gai/ha, and glufosinate is applied at a rate of about 200 gai/ha to about 400 gai/ha. In certain embodiments, the methods and compositions utilizing the compound of Formula (I) or salt or ester thereof in combination with glufosinate or salt or ester thereof are used to control at least one Conyza species including, but are not limited to, Conyza sumatrensis (Sumatran fleabane, ERISU), Conyza canadensis (Canadian fleabane, ERICA), Conyza bonariensis (hairy fleabane, ERIBO) or other related fleabane species (Conyza spp, ERISS).

In certain embodiments of the compositions and methods described herein, the compound of Formula (I) or salt or ester thereof is used in combination with at least one compound selected from the group consisting of: 2,4-D, 2,4-D EHE, 2,4-D DMA, 2,4-D choline, and/or 2,4-DB, and glufosinate or an agriculturally acceptable salts, esters, and amides thereof. In some embodiments, the weight ratio of the compound of Formula (I) or salt or ester thereof to at least one compound selected from the group consisting of: 2,4-D, 2,4-D EHE, 2,4-D DMA, 2,4-D choline, and/or 2,4-DB to glufosinate or an agriculturally acceptable salts, esters, and amides thereof is within the range of from about 1:1000:1000 to about 1:1:1. In certain embodiments, the weight ratio of the compound of Formula (I) or salt or ester thereof to at least one compound selected from the group consisting of: 2,4-D, 2,4-D EHE, 2,4-D DMA, 2,4-D choline, and/or 2,4-DB to glufosinate or an agriculturally acceptable salts, esters, and amides thereof is within the range of from about 1:400:400 to about 1:12.5:10. In certain embodiments, the weight ratio of the compound of Formula (I) or salt or ester thereof to at least one compound selected from the group consisting of: 2,4-D, 2,4-D EHE, 2,4-D DMA, 2,4-D choline, and/or 2,4-DB to glufosinate or an agriculturally acceptable salts, esters, and amides thereof is within the range of from about 1:200:200 to about 1:25:12.5. In one embodiment, the composition comprises the compound of Formula (I) or salt or ester thereof, 2,4-D DMA, and glufosinate, wherein the weight ratio of the compound of Formula (I) or salt or ester thereof to 2,4-D DMA to glufosinate is from about 1:1000:1000 to about 1:1:1 or from about 1:500:500 to about 1:100:50. In one embodiment, the composition comprises the compound of Formula (I) or salt or ester thereof, 2,4-D DMA, and glufosinate, wherein the weight ratio of the benzyl ester of the compound of Formula (I) or salt or ester thereof to 2,4-D DMA to glufosinate is from about 1:500:200 to about 1:100:50, from about 1:200:100 to about 1:130:70, or about 1:135:75.

The compositions disclosed herein could have utility in AAD1 and AAD12 monocot and dicot crops whereby there is crop tolerance to all 3 modes of action, providing growers with a solution to control susceptible and resistant broad/eat weeds, as well as to delay the development of resistance by the use of a 3 mode of action product.

The components of the compositions described herein can be applied either separately or as part of a multipart herbicidal system.

The compositions described herein can be applied in conjunction with one or more additional herbicides to control a wider variety of undesirable vegetation. When used in conjunction with other herbicides, the composition can be formulated with the other herbicide or herbicides, tank mixed with the other herbicide or herbicides or applied sequentially with the other herbicide or herbicides. Some of the herbicides that can be employed in conjunction with the compositions and methods described herein include, but are not limited to: 4-CPA; 4-CPB; 4-CPP; 3,4-DA; 3,4-DB; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, ferrous sulfate, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, fumiclorac, furyloxyfen, glyphosate salts and esters, halosafen, halauxifen, halauxifen-methyl, halosulfuron-methyl, haloxydine, haloxyfop-methyl, haloxyfop-P-methyl, hexachloroacetone, hexaflurate, hexazinone, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen-ethyl, parafluron, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac-methyl, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfurn-methyl, thiobencarb, tiafenacil, tiocarbazil, tioclorim, topramezone, tralkoxydim, triafamone, tri-allate, triasulfuron, triaziflam, tribenuron, tribenuron-methyl, tricamba, triclopyr choline salt, triclopyr esters and amines, tridiphane, trietazine, trifloxysulfuron, trifluralin, triflusulfuron, trifop, trifopsime, trihydroxytriazine, trimeturon, tripropindan, tritac tritosulfuron, vernolate, xylachlor and salts, esters, optically active isomers and mixtures thereof.

In some embodiments, the compositions described herein can be applied in conjunction with one or more additional herbicides to control a wider variety of undesirable vegetation. When used in conjunction with other herbicides, the composition can be formulated with the other herbicide or herbicides, tank mixed with the other herbicide or herbicides or applied sequentially with the other herbicide or herbicides. Some of the herbicides that can be employed in conjunction with the compositions and methods described herein include, but are not limited to: acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, ipfencarbazone, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 45100-03-7) and 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione; b5) from the group of the bleacher herbicides.

The compositions and methods described herein, can further be used in conjunction with glyphosate, 5-enolpyruvylshikimate-3-phosphate (EPSP) synthase inhibitors, glutamine synthetase inhibitors, dicamba, phenoxy auxins, pyridyloxy auxins, synthetic auxins, auxin transport inhibitors, aryloxyphenoxypropionates, cyclohexanediones, phenylpyrazolines, acetyl CoA carboxylase (ACCase) inhibitors, imidazolinones, sulfonylureas, pyrimidinylthiobenzoates, triazolopyrimidines, sulfonylaminocarbonyltriazolinones, acetolactate synthase (ALS) or acetohydroxy acid synthase (AHAS) inhibitors, 4-hydroxyphenyl-pyruvate dioxygenase (HPPD) inhibitors, phytoene desaturase inhibitors, carotenoid biosynthesis inhibitors, protoporphyrinogen oxidase (PPO) inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil on glyphosate-tolerant, EPSP synthase inhibitor-tolerant, glufosinate-tolerant, glutamine synthetase inhibitor-tolerant, dicamba-tolerant, phenoxy auxin-tolerant, pyridyloxy auxin-tolerant, auxin-tolerant, auxin transport inhibitor-tolerant, aryloxyphenoxypropionate-tolerant, cyclohexanedione-tolerant, phenylpyrazoline-tolerant, ACCase-tolerant, imidazolinone-tolerant, sulfonylurea-tolerant, pyrimidinylthiobenzoate-tolerant, triazolopyrimidine-tolerant, sulfonylaminocarbonyltriazolinone-tolerant, ALS- or AHAS-tolerant, HPPD-tolerant, phytoene desaturase inhibitor-tolerant, carotenoid biosynthesis inhibitor tolerant, PPO-tolerant, cellulose biosynthesis inhibitor-tolerant, mitosis inhibitor-tolerant, microtubule inhibitor-tolerant, very long chain fatty acid inhibitor-tolerant, fatty acid and lipid biosynthesis inhibitor-tolerant, photosystem I inhibitor-tolerant, photosystem II inhibitor-tolerant, triazine-tolerant, and bromoxynil-tolerant crops, and crops possessing multiple or stacked traits conferring tolerance to multiple chemistries and/or multiple modes of action via single and/or multiple resistance mechanisms. In some embodiments, the compound of formula (I) or salt or ester thereof and complementary herbicide or salt or ester thereof are used in combination with herbicides that are selective for the crop being treated and which complement the spectrum of weeds controlled by these compounds at the application rate employed. In some embodiments, the compositions described herein and other complementary herbicides are applied at the same time, either as a combination formulation or as a tank mix or as a sequential application.

In some embodiments, the compositions described herein are employed in combination with one or more herbicide safeners, such as AD-67 (MON 4660), benoxacor, benthiocarb, brassinolide, cloquintocet (mexyl), cyometrinil, cyprosulfamide, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, R29148 and N-phenyl-sulfonylbenzoic acid amides, to enhance their selectivity. In some embodiments, the safeners are employed in rice, cereal, corn, or maize settings. In some embodiments, the safener is cloquintocet acid or an ester or salt thereof. In certain embodiments, cloquintocet is utilized to antagonize harmful effects of the compositions on rice and cereals. In some embodiments, the safener is cloquintocet mexyl.

In some embodiments, the compositions described herein are employed in combination with one or more plant growth regulators, such as 2,3,5-tri-iodobenzoic acid, IAA, IBA, naphthaleneacetamide, a-naphthaleneacetic acids, benzyladenine, 4-hydroxyphenethyl alcohol, kinetin, zeatin, endothal, ethephon, pentachlorophenol, thidiazuron, tribufos, aviglycine, ethephon, maleic hydrazide, gibberellins, gibberellic acid, abscisic acid, ancymidol, fosamine, glyphosine, isopyrimol, jasmonic acid, maleic hydrazide, mepiquat, 2,3,5-tri-iodobenzoic acid, morphactins, dichlorflurenol, flurprimidol, mefluidide, paclobutrazol, tetcyclacis, uniconazole, brassinolide, brassinolide-ethyl, cycloheximide, ethylene, methasulfocarb, prohexadione, triapenthenol and trinexapac.

In some embodiments, the plant growth regulators are employed in one or more crops or settings, such as rice, cereal crops, corn, maize, broadleaf crops, oilseed rape/canola, turf, pineapple, sugarcane, sunflower, pastures, grasslands, rangelands, fallowland, tree and vine orchards, plantation crops, vegetables, and non-crop (ornamentals) settings. In some embodiments, the plant growth regulator is mixed with the compound of formula (I), or mixed with the compound of formula (I) and an imidazolinone to cause a preferentially advantageous effect on plants.

In some embodiments, compositions provided herein further comprise at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions. They can also be provided as a pre-mix or tank mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C9-C11 alkylpolyglycoside; phosphated alcohol ethoxylate; natural primary alcohol (C12-C16) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8E0); tallow amine ethoxylate (15 EO); PEG(400) dioleate-99.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

In some embodiments, the compositions described herein further comprise one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical Publishing Co., New York, 1980-81. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C18 ethoxylate; alcohol-alkylene oxide addition products, such as tridecyl alcohol-C16 ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; poly-ethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include but are not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

In some embodiments, the concentration of the active ingredients in the compositions described herein is from about 0.0005 to 98 percent by weight. In some embodiments, the concentration is from about 0.0006 to 90 percent by weight. In compositions designed to be employed as concentrates, the active ingredients, in certain embodiments, are present in a concentration from about 0.1 to 98 weight percent, and in certain embodiments about 0.5 to 90 weight percent. Such compositions are, in certain embodiments, diluted with an inert carrier, such as water, before application. The diluted compositions usually applied to weeds or the locus of weeds contain, in certain embodiments, about 0.0006 to 3.0 weight percent active ingredient and in certain embodiments contain about 0.01 to 1.0 weight percent.

The present compositions can be applied to weeds or their locus by the use of conventional ground or aerial dusters, sprayers, and granule applicators, by addition to irrigation or paddy water, and by other conventional means known to those skilled in the art.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### Examples

Results in Examples are greenhouse trial results.

Seeds or nutlets of the desired test plant species were planted in a soil matrix prepared by mixing a loam or sandy loam soil (e.g., 28.6 percent silt, 18.8 percent clay, and 52.6 percent sand, with a pH of about 5.8 and an organic matter content of about 1.8 percent) and calcareous grit in an 80 to 20 ratio. The soil matrix was contained in plastic pots with a volume of 1 quart and a surface area of 83.6 cm2. When required to ensure good germination and healthy plants, a fungicide treatment and/or other chemical or physical treatment was applied. The plants were grown for 8-22 days in a greenhouse with an approximate 14 h photoperiod which was maintained at about 29° C. during the day and 26° C. during the night. Nutrients (Peters Excel® 15-5-15 5-Ca 2-Mg and iron chelate) were applied in the irrigation solution as needed and water was added on a regular basis. Supplemental lighting was provided with overhead metal halide 1000-Watt lamps as necessary. The plants were employed for testing when they reached the first through fourth true leaf stage.

Treatments comprised of the acid or esters of halauxifen-methyl (methyl 4-amino-3-chloro-6-(4-chloro-2-fluoro-3-methoxyphenyl)picolinate), each formulated as an SC (suspension concentrate), and various herbicidal components alone and in combination. A form of the compound of Formula I were applied on an acid equivalent basis.

A form of the compound of formula I tested include:

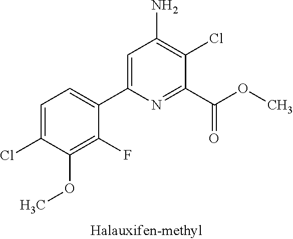 [SMILES: COC(=O)c1nc(-c2ccc(Cl)c(OC)c2F)cc(N)c1Cl]

Treatment requirements were calculated based upon the rates being tested, the concentration of active ingredient or acid equivalent in the formulation, and a 12 mL application volume at a rate of 187 L/ha.

For treatments comprised of formulated compounds, measured amounts of compounds were placed individually in 25 mL glass vials and diluted in a volume of 1.25% (v/v) Agri-Dex® crop oil concentrated to obtain 12× stock solutions. If a test compound did not dissolve readily, the mixture was warmed and/or sonicated. Application solutions were prepared by adding an appropriate amount of each stock solution (e.g., 1 mL) and diluted to the appropriate final concentrations with the addition of 10 mL of an aqueous mixture of 1.25% (v/v) crop oil concentrate so that the final spray solutions contained 1.25+/−0.05% (v/v) crop oil concentrate.

For treatments comprised of technical compounds, weighed amounts can be placed individually in 25 mL glass vials and dissolved in a volume of 97:3 v/v acetone/DMSO to obtain 12× stock solutions. If a test compound does not dissolve readily, the mixture can be warmed and/or sonicated. Application solutions can be prepared by adding an appropriate amount of each stock solution (e.g., 1 mL) and diluted to the appropriate final concentrations with the addition of 10 mL of an aqueous mixture of 1.5% (v/v) crop oil concentrate so that the final spray solutions contain 1.25% (v/v) crop oil concentrate. When technical materials are used, the concentrated stock solutions can be added to the spray solutions so that the final acetone and DMSO concentrations of the application solutions are 16.2% and 0.5%, respectively.

For treatments comprised of formulated and technical compounds, weighed amounts of the technical materials were placed individually in 25 mL glass vials and dissolved in a volume of 97:3 v/v acetone/DMSO to obtain 12× stock solutions, and measured amounts of the formulated compounds were placed individually in 25 mL glass vials and diluted in a volume of 1.5% (v/v) crop oil concentrate or water to obtain 12× stock solutions. If a test compound did not dissolve readily, the mixture was warmed and/or sonicated. Application solutions were prepared by adding an appropriate amount of each stock solution (e.g., 1 mL) and diluted to the appropriate final concentrations with the addition of an appropriate amount of an aqueous mixture of 1.5% (v/v) crop oil concentrate so that the final spray solutions contained 1.25% (v/v) crop oil concentrate. As required, additional water and/or 97:3 v/v acetone/DMSO was added to individual application solutions so that the final acetone and DMSO concentrations of the application solutions being compared were 8.1% and 0.25%, respectively.

All stock solutions and applications solutions were visually inspected for compound compatibility prior to application. Spray solutions were applied to the plant material with an overhead Mandel track sprayer equipped with an 8002E nozzle calibrated to deliver 187 L/ha over an application area of 0.503 m2 at a spray height of 18 to 20 inches (46 to 50 cm) above average plant canopy height. Control plants were sprayed in the same manner with the solvent blank.

The treated plants and control plants were placed in a greenhouse as described above and watered by sub-irrigation to prevent wash-off of the test compounds. After approximately 7, 28, 43 days (DAA; Days After Application), the condition of the test plants as compared with that of the untreated plants was determined visually and scored on a scale of 0 to 100 percent where 0 corresponds to no injury or growth inhibition and 100 corresponds to complete kill.

The compounds tested, application rates employed, plant species tested, and results are given in Table 1.

Table 1 illustrates weed control for foliar applications of compositions comprising halauxifen-methyl+2,4-D-dimethylammonium (2,4-D-DMA)+glufosinate on various broadleaf weeds. Table 1 demonstrates that an application of a premixture (“Chemical 1”; 3.8 gae/L halauxifen-methyl+520.4 gae/L 2,4-D DMA) at 654.99 gai/ha and glufosinate at 49 gai/ha provided effective control of ERISS (Conyza spp). The compositions disclosed herein can be used in burndown and fallow crop applications or in herbicide tolerant crops. These compositions can be used for broad-spectrum control of broadleaf weeds including, but not limited to, ALS, auxinic, HPPD, PPO, glufosinate and glyphosate resistant broadleaf weeds. The compositions disclosed herein can have utility in AAD1 and AAD12 monocot and dicot crops whereby there is crop tolerance to all 3 modes of action, providing growers with a solution to control susceptible and resistant broadleaf weeds, as well as to delay the development of resistance by the use of 3 modes of action product. The compositions disclosed herein can be used in non-crop and R&P/IVM situations, post directed in perennial crops, and potentially across many crops where there is tolerance to all 3 modes of action.

TABLE 1
Weed Control Results on ERISU (Conyza sumatrensis, Sumatran fleabane) Populations with Halauxifen-methyl +
2,4-D dimethylammonium (2,4-D DMA) + glufosinate Tankmixes at indicated Days After Application (DAA)

| | | | | | Chem 1 | | | Chem 2 | Combined | Combined | | |
|---|---|---|---|---|---|---|---|---|---|---|---|---|
| | | | | | Actual | | | Actual | Actual | Expected | | |
| | | Trt. | | Chem 1 | Mean % | | Chem 2 | Mean % | Mean % | Mean % | | |
| | Bayer | Eval. | | Rate | Weed | | Rate | Weed | Weed | Weed | # | P > |
| TRIAL | Code | Interval | Chemical 1 | (gai/ha) | Control | Chemical 2 | (gai/ha) | Control | Control | Control | Obs. | t |
| 1 | ERISU | 17DAA | halauxifen-methyl + | 654.99 | 35.00 | glufosinate- | 366 | 58.75 | 80.00 | 73.19 | 4 | 0.074 |
| | | | 2,4-D | | | ammonium | | | | | | |
| | | | dimethylammonium | | | | | | | | | |
| 1 | ERISU | 28DAA | halauxifen-methyl + | 654.99 | 61.25 | glufosinate- | 366 | 71.25 | 97.00 | 89.00 | 4 | 0.058 |
| | | | 2,4-D | | | ammonium | | | | | | |
| | | | dimethylammonium | | | | | | | | | |
| 1 | ERISU | 43DAA | halauxifen-methyl + | 654.99 | 71.25 | glufosinate- | 366 | 78.75 | 97.50 | 94.06 | 4 | 0.252 |
| | | | 2,4-D | | | ammonium | | | | | | |
| | | | dimethylammonium | | | | | | | | | |
| 2 | ERISU | 17DAA | halauxifen-methyl + | 654.99 | 36.25 | glufosinate- | 366 | 71.25 | 94.50 | 81.50 | 4 | 0.025 |
| | | | 2,4-D | | | ammonium | | | | | | |
| | | | dimethylammonium | | | | | | | | | |
| 2 | ERISU | 28DAA | halauxifen-methyl + | 654.99 | 48.75 | glufosinate- | 366 | 85.00 | 97.50 | 92.38 | 4 | 0.023 |
| | | | 2,4-D | | | ammonium | | | | | | |
| | | | dimethylammonium | | | | | | | | | |
| 2 | ERISU | 43DAA | halauxifen-methyl + | 654.99 | 74.50 | glufosinate- | 366 | 97.50 | 100.00 | 99.29 | 4 | 0.198 |
| | | | 2,4-D | | | ammonium | | | | | | |
| | | | dimethylammonium | | | | | | | | | |

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety to the extent they are not inconsistent with the explicit teachings of this specification.

What is claimed is:

1. A herbicidal composition comprising a herbicidally effective amount of (a) a compound of Formula (I) 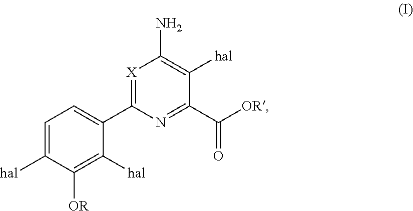
wherein X represents CH or N, hal represents F, Cl or Br, R is methyl or ethyl, and R′ is H, methyl or ethyl, or an agriculturally acceptable salt or ester thereof, (b) a second herbicide comprising at least one phenoxy herbicide, or an agriculturally acceptable salts, esters, and amides thereof and (c) a third herbicide comprising at least one organophosphorus herbicide, or an agriculturally acceptable salts, esters, and amides thereof.

2. The composition according to claim 1, wherein X is CH.

3. The composition according to claim 1, wherein R is methyl and R′ is methyl.

4. The composition according to claim 1, wherein the second herbicide (b) comprises at least one compound selected from the group consisting of: 2,4-D, 2,4-D EHE, 2,4-D DMA, 2,4-D choline, and/or 2,4-DB.

5. The composition according to claim 1, wherein the third herbicide (c) comprises at least one compound selected form the group consisting of: glufosinate, amiprofos-methyl, anilofos, bensulide, bilanafos, butamifos, fosamine, and piperophos, or an agriculturally acceptable salts, esters, and amides thereof.

6. The composition according to claim 1, wherein the compound of Formula (I) is halauxifen-methyl, the second herbicide (b) is 2,4-D DMA, and the third herbicide (c) is glufosinate-ammonium.

7. The composition according to claim 1, further comprising an agriculturally acceptable adjuvant or carrier.

8. The composition according to claim 1, further comprising at least one herbicide safener.

9. The composition according to claim 1, further comprising at least one additional herbicide.

10. The composition according to claim 1, wherein the weight ratio between (a), (b), and (c) is from about 1:500:70 to about 1:1:1.

11. A method of controlling undesirable vegetation, comprising the steps of: contacting a plant, wherein the plant is undesirable vegetation or the locus thereof, soil or water, wherein the soil or the water allows for the growth of the undesirable vegetation, with a herbicidally effective amount of a combination comprising (a) a compound of the formula (I): 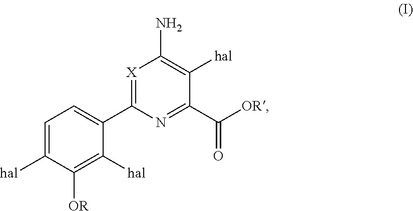
wherein X represents CH or N, hal represents F, Cl or Br, R is methyl or ethyl, and R′ is H, methyl or ethyl, or an agriculturally acceptable salt or ester thereof, (b) a second herbicide comprising at least one phenoxy herbicide, or an agriculturally acceptable salts, esters, and amides thereof and/or (c) a third herbicide comprising at least one organophosphorus herbicide, or an agriculturally acceptable salts, esters, and amides thereof.

12. The method according to claim 11, wherein the second herbicide (b) comprises at least one compound selected from the group consisting of: 2,4-D, 2,4-D EHE, 2,4-D DMA, 2,4-D choline, and/or 2,4-DB.

13. The method according to claim 11, wherein the third herbicide (c) comprises at least one compound selected form the group consisting of: glufosinate, amiprofos-methyl, anilofos, bensulide, bilanafos, butamifos, fosamine, and piperophos, or an agriculturally acceptable salts, esters, and amides thereof.

14. The method according to claim 11, wherein the compound of Formula (I) is halauxifen-methyl, the second herbicide (b) is 2,4-D DMA, and the third herbicide (c) is glufosinate-ammonium.

15. The method according to claim 11, wherein the ratio between (a), (b), and (c) is from about 1:400:70 to about 1:1:1.

16. The method according to claim 11, wherein the undesirable vegetation is controlled in direct-seeded, water-seeded and transplanted rice, cereals, wheat, barley, oats, rye, sorghum, corn/maize, sugarcane, sunflower, oilseed rape, canola, sugar beet, soybean, cotton, pineapple, pastures, grasslands, rangelands, fallowland, turf, tree and vine orchards, aquatics, industrial vegetation management (IVM) or rights of way (ROW).

17. The method according to claim 11, wherein the (a), (b), and (c) are applied pre-emergently to the weed or the crop.

18. The method according to claim 11, wherein the undesirable vegetation is controlled in glyphosate-, 5-enolpyruvylshikimate-3-phosphate (EPSP) synthase inhibitor-, glufosinate-, glutamine synthetase inhibitor-, dicamba-, phenoxy auxin-, pyridyloxy auxin-, synthetic auxin-, auxin transport inhibitor-, aryloxyphenoxypropionate-, cyclohexanedione-, phenylpyrazoline-, acetyl CoA carboxylase (ACCase) inhibitor-, imidazolinone-, sulfonylurea-, pyrimidinylthiobenzoate-, triazolopyrimidine-, sulfonylaminocarbonyltriazolinone-, acetolactate synthase (ALS) or acetohydroxy acid synthase (AHAS) inhibitors-, 4-hydroxyphenyl-pyruvate dioxygenase (HPPD) inhibitor-, phytoene desaturase inhibitor-, carotenoid biosynthesis inhibitor-, protoporphyrinogen oxidase (PPO) inhibitor-, cellulose biosynthesis inhibitor-, mitosis inhibitor-, microtubule inhibitor-, very long chain fatty acid inhibitor-, fatty acid and lipid biosynthesis inhibitor-, photosystem I inhibitor-, photosystem II inhibitor-, triazine-, or bromoxynil-tolerant crops.

19. The method according to claim 18, wherein the tolerant crop possesses multiple or stacked traits conferring tolerance to multiple herbicides or multiple modes of action.

20. The method according to claim 11, wherein the undesirable vegetation comprises a herbicide resistant or tolerant weed.
